(19) United States
(12) Patent Application Publication
(10) Pub. No.: US 2005/0093999 A1
(43) Pub. Date: May 5, 2005

(54) Photographed subject authentication system

(76) Inventor: Yorihiro Yamaya, Tokyo (JP)

Correspondence Address: CANTOR COLBURN LLP, 55 Griffin Road South, Bloomfield, CT, 06002, US

(21) Appl. No.: 10/973,033

(22) Filed: Oct. 25, 2004

(30) Foreign Application Priority Data
Oct. 30, 2003 (JP) JP2003-370299

(51) Int. Cl. H04N 5/76

(52) U.S. Cl. 348/231.99

(57) ABSTRACT

A photographed subject authentication system comprising: a compressed image data writing device for writing the first compressed image data and related information into the photographed object authentication card; a compressed image data reading device for reading a third compressed image data from the photographed subject authentication card; a data specifying device for specifying the original image data corresponding to the first compressed image data and the compression condition read based on the obtained related information; and a second compression device for compressing the specified original image data based on the specified compression condition to obtain second compressed image data, wherein the data verifying device determines that the third compressed image data is equal to the first compressed image data when the result of the comparison is that the third compressed image data is equal to the second compressed image data.

### FIELD OF THE INVENTION

The present invention relates to a photographed subject authentication system which performs photographed subject authentication using a photographed subject authentication card.

### BACKGROUND OF THE INVENTION

ID cards such as employee identification cards, general identification cards, various types of licenses and the like are being used. Some of these cards have personal information printed directly on the card surface or alternatively, the personal information recorded on IC memory which is built into the card.

In order to prevent fraudulent use of the ID card, there have been proposed ID cards for reading devices which verify image information obtained from the facial photograph printed on the surface of the ID card with the compressed image information which is written in a two-dimensional barcode (Patent Document 1), and electronic card issuing systems which verify the facial photograph that is electronically recorded on the ID card with photographic image information obtained from a photographing device (Patent Document 2).
[Patent Document 1] Japanese Patent Application Laid-Open No. 8-129634 publication
[Patent Document 2] Japanese Patent Application Laid-Open No. 2002-269504 publication

However, in the case where facial photograph printed on the card surface and image data read from a two-dimensional bar code is used for verification, when the card becomes dirty or the image deteriorates due to the passage of time, the verification information may be lost. Furthermore, when the information recorded on the card is verified only with a photograph image obtained by photographing, changes of the photographed subject with the passage of time, growing or shaving of a beard, changes in hairstyle or the like may prevent matching.

The present invention was conceived in view of the above-described problems and an object thereof is to provide a photographed subject authentication system that makes it possible to accurately perform authentication.

### SUMMARY OF THE INVENTION

(1) A photographed subject authentication system comprising: a storing means for storing the original image data obtained from a photographed subject and compression conditions for compressing the original image data; a compressed image data reading means for reading first compressed image data from a photographed subject authentication card on which is recorded first compressed image data created by compressing the original image data based on the compression conditions; a related information obtaining means for obtaining related information pertaining to the photographed subject from the photographed subject authentication card; a data specifying means for specifying the original image data corresponding to the first compressed image data and the compression conditions which were read from the storing means based on the obtained related information; a compression means for creating second compressed data by compressing the specified original image data based on the specified compression conditions; and a data verifying means which compares and verifies the second compressed image data with the first compressed image data which was read.

(2) The photographed subject authentication system of (1), wherein the compression conditions are attached to the original image data and/or the first compressed image data are attached as metadata.

(3) The photographed subject authentication system of (1), wherein the original image data is image data compressed using conditions by which the photographed subject image data obtained by photographing the photographed subject can be decompressed to have image quality which is the same as the photographed subject image data.

(4) The photographed subject authentication system of (3), wherein the compression format used when creating the original image data from the photographed subject image data and the compression format used when creating the first and second compressed image data from the original image data are the same compression format, and the first and second compression image data are created by reducing the data amount of the compressed image data in its original state without decoding to the original image data.

(5) The photographed subject authentication system of any of (1) to (4), comprising a photographed subject image obtaining means for obtaining image data from the photographed subject; an image verifying means for verifying the first compressed image data read by the compressed image data reading means, or the specified original image data specified from the specifying means with the image data obtained by the photographed subject image data obtaining means, and photographed subject authentication is performed based on the results of the verification by the image data verifying means and the results of the verification by the image verifying means.

(6) The photographed subject authentication system of any of (1) to (5), wherein the photographed subject image is recorded on the surface of the photographed subject authentication card.

(7) The photographed subject authentication system of any of claims (1) to (6), comprising a display means for displaying the first compressed image data read by the compressed image data reading means, or the original image data specified by the data specifying means.

According to (1), because the original image data corresponding to the first compressed image data read from the photographed subject authentication card based on the related information obtained from the photographed subject authentication card and the compression conditions are specified, and the second compressed image data is created by compressing the specified original image data based on the specified compression conditions, and the second compressed image and the first compressed image data read by the photographed subject card are compared and verified, a determination can be made as to whether the first compressed image data recorded on the photographed subject authentication card is that created from the original image data stored on the storing means. Thus, a determination can be made as to whether the information on the photographed subject authentication card has been tampered with, and photographed subject authentication can be performed.

According to (2), because the compression data is attached to the original image data and/or the first compressed image data as metadata, the step of causing the compression conditions and the original image data and/or the first compressed image data to correspond may be omitted.

According to (3), because the storing means stores compressed original image data using conditions such that the original image data can be decompressed to the same image quality as the photographed subject image data, more photographed subject data can be stored at the minimum size.

According to (4), because when the original image data is created from the photographed subject image data and when the first and second compressed image data are created from the original image, the same compression format is used, and the first and second compression image data are created by reducing the data amount of the compressed image data without decoding to the original image data, the memory capacity that is used can be decreased.

According to (5), because authentication is performed based on the results of verification by the data verifying means of the first compressed image data read by the compressed image data reading means or the original image data specified by the specifying means, with image data obtained by the image data obtaining means, photographed subject authentication can be accurately performed.

According to (6), because the photographed subject image is recorded on the surface of the card, it can be confirmed that the image on the card surface matches the cardholder.

According to (7), because the first compressed image data or the original image data is displayed, a confirmation can be made as to whether the displayed image matches the cardholder.

### BRIEF DESCRIPTION OF THE DRAWINGS

FIG. 1 is a diagram of the system configuration for the photographed subject authentication system 1 of the embodiment of this invention.

FIG. 2 is a schematic diagram showing the configuration of the photographed subject authentication card 50.

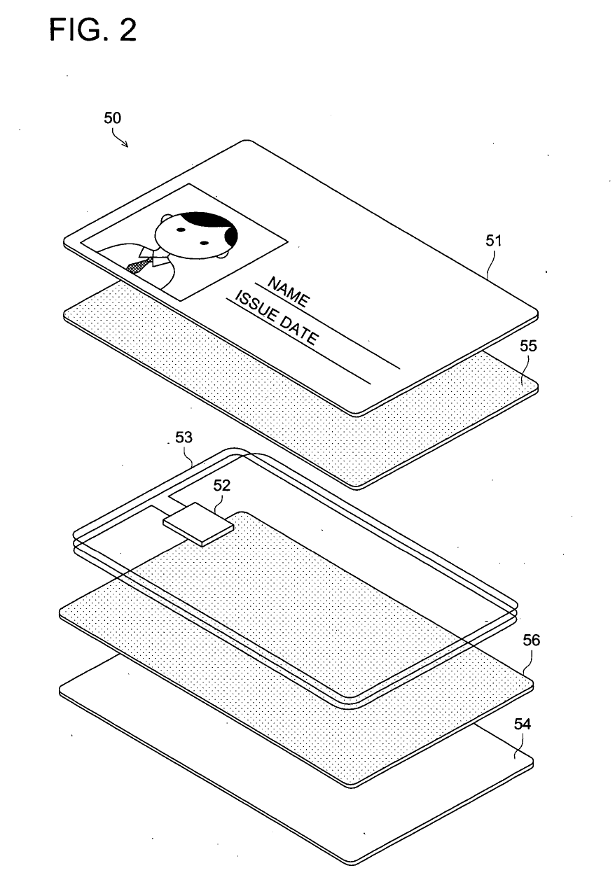

FIG. 3 is a block diagram of the functional configuration of the PC 10.

FIG. 4 is a flowchart for explaining the photographed subject authentication process performed in the photographed subject authentication system 1.

### DETAILED DESCRIPTION OF PREFERRED EMBODIMENTS

In the following, the embodiment of this invention is described in details with reference to the drawings.

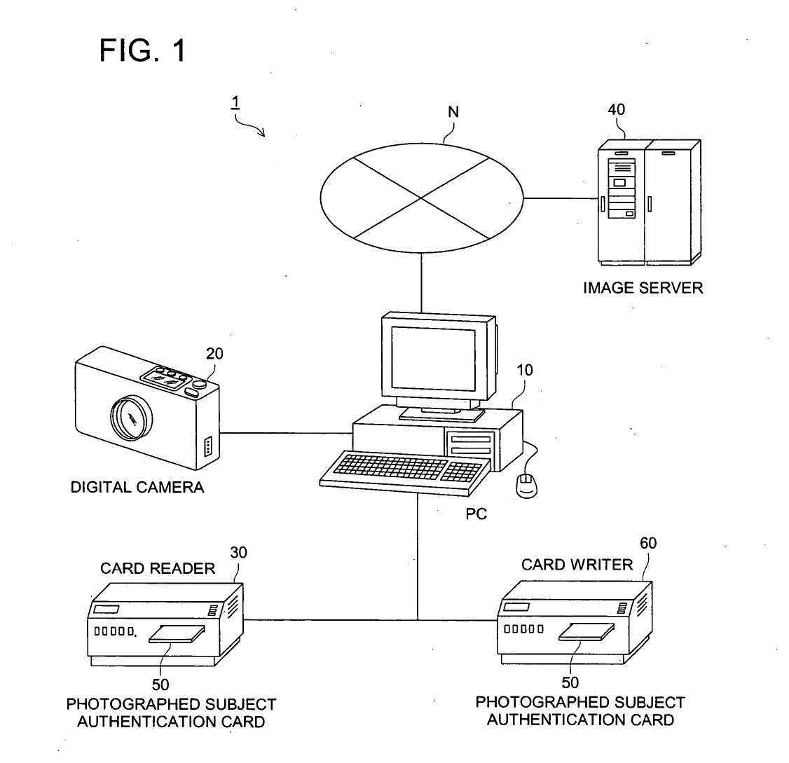

FIG. 1 shows the system configuration for the photographed subject authentication system 1 of this invention.

The photographed subject authentication system 1 comprises a PC (personal computer) 10, a digital camera 20, a card reader 30 for obtaining data recorded on a photographed subject authentication card 50, and an image server 40. The digital camera 20, the card reader 30 and the card writer 60 respectively are directly connected to the PC 10, and the PC 10 and image server 40 are connected via the network N.

The image server 40 is a recording medium formed of a hard disk and the like. The image server 40 stores the original image data obtained from the photographed subject and the compression conditions for compressing the original image data.

Original image data refers to compressed image data in which the photographed object image data obtained from photographing the subject that has been compressed using conditions such that the data can be decompressed to the same image quality as the photographed image data. Data can be decompressed to the same image quality means the same image information as the original image information can be decompressed (so-called reversible compression), or refers to the case where the PSNR value of the decompressed information corresponding to the original image information is 40 dB or more (irreversible compression). When the PSNR value is less than 40 dB, or in other words, when the image quality is low, the definitive portion of the image of the photographed subject such as a mole on the face or the outline of the eyes nose and mouth may become blurred.

Examples of the reversible compression format include JPEG (Joint Photographic Coding Experts Group) 2000, TIFF (Tagged Image File Format), JPEG-LS (Lossless) and the like. Examples of the irreversible compression formats include JPEG 2000, JPEG and the like.

The JPEG 2000 format is an image compression format which divides image data into a plurality of layered data for each resolution or density resolving power using the wavelet conversion or the like, and the layered data for the divided resolution powers or the density resolving powers are encoded in order of class, and compressed as one file and stored. The JPEG 2000 format is specified by the ISO (International Organization for Standardization) and the IEC (International Electro-technical Commission) in December 2000 (ISO/IEC 15444-1).

The JPEG 2000 format does not process image data by the block and thus block noise is not generated. In addition, because orthogonal exchange is performed within a wide range for low frequency regions, and orthogonal exchange is possible in a narrow range for the low frequency region, spatial widening of the quantification effect in the edge periphery of the image is controlled. In the DCT (Discrete Cosine Transform) which is used in JPEG, because the cosine is an infinite function, processing for each wave frequency region is logically difficult.

That is to say, by using the JPEG 2000 format, block noise and mosquito noise which is a problem with JPEG is controlled, and if the image quality is about the same in effect, the data can be compressed at a higher compression rate.

It is to be noted that JPEG 2000 also has the function of tile division for processing load reduction, but this is unfavorable because when high compression processing is done, dividing borders which resemble block noise appear on the image causing so-called tile warp.

The PSNR (Peak Signal to Noise Ratio) value is the measurement for deterioration of the image due to compression encoding and is defined by the following equation.

$$PSNR = 10 \cdot {log}_{10} \frac{N \times M \times {T}^{2}}{{\sum }_{i = 1}^{N} {\sum }_{j = 1}^{M} {\{ p ( i , j ) - {p}^{′} ( i , j ) \}}^{2}} ( dB ) \qquad [ Equation 1 ]$$

N and M are the vertical and horizontal pixel numbers for the image; p(i, j) is the pixel value for the location of the original image; p(i, j) is the image location p(i, j) when the compressed image is decoded; and T is the is the image gradation number −1 (for a 8 bit image it is 256−1=255).

The compression conditions refer to the compression format used at the time of image compression, the target compression rate, the target file size, the target bit rate and the like. Examples include the Q table used at the time of compression in the case of JPEG, and parameter information such as the code block size, the resolution level, the filter used in DWT (Discrete Wavelet Transform), the quantification step size, and the layer division conditions and the like in the case of JPEG 2000.

The compression conditions may be stored on the image server 40 separately from the original image data, but the compression conditions may also be added to the original image data as metadata. In the former case, a means for causing the original data and the compression data to correspond is necessary, but in the latter case this is not necessary, and a unique link is determined.

Examples of specific means for attaching the compression data include the basic type file format of JPEG 2000 which is one compression format in which it is possible to ascribe additional information corresponding to the image data which has been compression encoded, and the XML formatted information can be recorded therein (ISO/IEC 15444-1). Because the compression conditions are in the XML format, the metadata can be recorded. Furthermore, another compression format is using the application data segment (Appn) in JPEG for example to record the compression conditions.

Furthermore, the compression conditions may be automatically recorded by the parameters in the marker segments and the like, and in this case they need not be recorded separately as the compression conditions.

In the case where the original data is compressed to ½-⅓ of the photographed subject image data prior to compression, the image server 40 stores 2-3 times the amount of data compared to storing the photographed subject image data prior to compression.

The photographed subject authentication card 50 will be described in the following.

The photographed subject authentication card 50 comprises a surface sheet 51, an IC chip 52, a coil antenna 53 which is connected to the IC chip 52, and a bottom surface sheet 54, and is adhered by adhesive sheets 55 and 56. The memory capacity of the IC chip 52 is 2 KB.

The facial image, name and the like of the photographed subject (card holder) are recorded on the surface (surface sheet 51) of the photographed subject authentication card 50. For example, the facial image on the card surface may be printed at 400 DPI (dots per inch) with a size of 2.4 cm×3 cm.

The IC chip 52 in the photographed subject authentication card 50 has the first compressed image data and related information pertaining to the photographed subject electrically recorded therein.

First compressed image data refers to compressed image data created by compressing the original image data stored in the image server 40 to an image data size that corresponds with the storage capacity of the IC chip 52 based on compression conditions stored in the image server 40. Examples of the compression format include JPEG and JPEG 2000. However, in the case where high compression processing in which the bit rate subsequent to compression is to be less than 1.00 bpp (bits per pixel), JPEG 2000 is preferable. When the size of the original image data is less than the memory capacity of the IC chip 52, the original image data may be recorded in the IC chip 52 without being compressed.

In addition, when the first compressed image data is being created, the original image data may be encoded once and then compressed again, but at the time of creating the original image data from the photographed image subject image data, when the first compressed image data is created from the original image data, if JPEG 2000 is also used, compression can be done by using the scalability function. Scalability is a function that allows decompression from the compressed data of an image with quality in accordance with the application, and by decompressing only a portion of the compressed data, the resolution of the image to be played (number of vertical and horizontal pixel) and the image quality may be changed. That is to say, compression data can be obtained by discarding coding information other than resolution level for the desired data size or bit plane, layer, and component (color). Furthermore, by not decoding, the memory capacity used is decreased. Based on these features, when original image data and first compressed image data are created, it preferable that JPEG 2000 is also used.

Examples of related information pertaining to the photographed subject include file names and the like on the image server 40, IDs for specifying the original image data, time of photographing, information for identifying the photographing site, license number, credit card number, residence card, seal registration number, employee number, medical certificate number, automobile number, certificate number, name of photographed subject, age and the like.

Related information may be recorded separately from the first compressed image data, but it may also be attached to the first compressed image data as metadata. In the former case, a means for causing the image data and the related information to correspond is necessary, but in the latter case this is not necessary, and a unique link is determined.

Furthermore, compression conditions may be added to the first compressed image data as metadata.

In the case where the related information is added to the original image data as metadata, all of the related information may be also be added to the first compressed image data, or only the necessary information may be selected and added. By adding only the minimum information, the equivalent capacity can be used for image data, and the image quality of the recorded data will be improved to the same extent.

An example of a specific means for attaching the related information is recording the related information in XML format as the metadata in JPEG 2000. If there is only a small amount of related information, it can be recorded as COM marker segment information which can record comments as binary data. In JPEG the application segment (Appn) can be used to record related information.

The PC 10 exercises general control of the devices in the photographed subject authentication system 1.

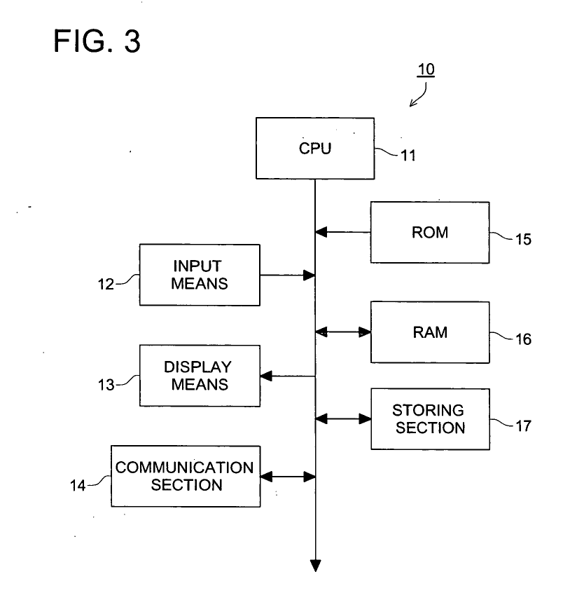

As shown in FIG. 3, the PC 10 comprises the CPU (Central Processing Unit) 11, the input means 12, the display means 13, the communication section 14, the ROM (Read Only Memory) 15, the RAM (Random Access Memory) 16 and the storing section 17.

The CPU 11 opens the instructed programs from among the programs stored in the ROM 15 in the work area of the RAM 16 in accordance with the commands input from the input means 12 or the data input from the communication section 14, and the processes are performed through cooperation with the programs, and the results of the processes are stored in a prescribed region on the RAM 16, and displayed by the display means 13.

The CPU 11 searches for the original image data corresponding to the first compressed image data and the compression conditions for compressing the original image data at the image server 40, based on information, such as ID number or file name and the like which can specify an image from related information obtained by the card reader 30, and thus functions as a data specifying means.

The CPU 11 compresses the specified original image data using specified compression conditions, and functions as the compression means for creating the second compressed image data. In this case, as is the case when the first compressed image data is created, compression formats such as JPEG and JPEG 2000 are used.

In addition, the CPU 11 functions as a data verifying means for comparing and verifying the second compressed image data with the third compressed image data read by the card reader 30 (which is assumed to be the first compressed image data, but this has not yet been confirmed). The binary data itself may be verified, or after encoding both, each set of information may be verified. In the case where the second compressed image data and the third compressed image data match, the compressed image data which is recorded on the card is determined to be the same as the first compressed image data, and thus determined to have been created from the specified original image data in the image server 40.

The CPU 11 functions as an image verifying means for verifying the photographic image data which is newly photographed by the digital camera 20 with the specified original image data. It is to be noted that the photographic image data may also be verified with the first compressed image data.

The method disclosed in the Japanese Patent Application Laid-Open No. 2002-251380 may be used as the method for verifying facial images. The face portions of the image data to be verified are respectively detected, and the respective facial image data are subjected to processing such as horizontal movement, enlargement or reduction, or rotation and the like, and normalized to the optimal size. The facial image data which has been normalized is subjected to wavelet conversion, and the facial organs (eye, nose, cheekbone, mouth, chin and the like) may be detected in detail at each position, and special features may be extracted.

The special features of the facial image that were obtained from both sets of image data are compared and verified, and the similarity level is calculated. If the calculated similarity level exceeds a threshold value, both photographed subjects are determined to match, while if the calculated similarity level is less than the threshold value, the photographed subjects are determined to be a mismatch. It is to be noted that the method for verifying the facial image is not limited to this method, may be any appropriate or suitable method.

The input means 12 may comprise a keyboard which includes various keys such as cursor keys or number keys, and a pointing device such as mouse, and pressing signals are output to the CPU 11 by operating the keys.

The display means 13 is a monitor comprising a CRT (Cathode Ray Tube) or LCD (Liquid Crystal Display) and the like, and images are displayed in accordance with the display signals from the CPU 11. For example, the display means 13 displays first compressed image data read by the card reader 30, or specified original image data from the image server 40.

The communication section 14 is an interface for sending various types of information between the devices.

The ROM 15 comprises non-volatile semiconductor memory, and it stores various programs which are executed by the CPU 11 and the like.

The RAM 16 comprises a writable semiconductor element. The RAM 16 is a storing medium which temporarily stores data, and has a program area for opening programs for executing CPU 11 and a data area for storing results of processing by the CPU11 and the like.

The memory section 17 comprises a magnetic or an optical recording medium or semiconductor memory and the like, and stores various types of information such as the first compressed image data read and related information read by the card reader 30, the original image data and compression conditions specified from the image server 40, and photographic image data photographed by the digital camera 20 and the like.

The digital camera 20 is a photographed subject image capturing means for photographing a subject, and capturing image data. Examples of the photographed subject image capturing means include image capturing devices for photographing a subject such as an analog video camera, a digital video camera, a digital still camera and the like, or an image reading device such as a scanner or the like which can read images printed on the surface of a card.

The card reader 30 reads the photographed subject authentication card 50, and reads the compressed image data and related information recorded on the IC chip 52. That is to say, the card reader 30 functions as a compressed image data reading means and as a related information obtaining means.

Examples of the network N include a LAN (Local Area Network), a WAN (Wide Area Network), and the internet, and telephone line network, ISDN (Integrated Service Digital Network), ADSL (Asymmetric Digital Subscriber Line) network, mobile communication network, communication satellite circuits, CATV circuits, optical communication circuits, wireless communication circuits and the like.

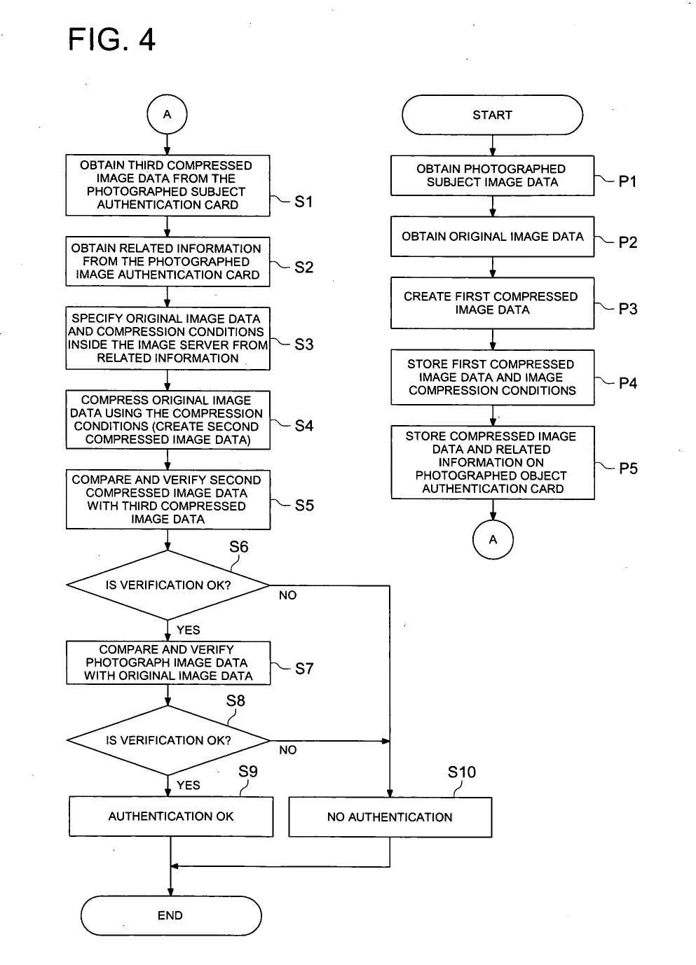

FIG. 4 is a flow chart for explaining the photographed subject authentication process which is performed in the photographed subject authentication system 1.

First, the steps for creating the photographed subject authentication card will be described in Steps P1 to P5 The subject is photographed by the subject image capturing means (such as digital camera 20) to obtain the subject image data (Step P1).

The original image data is obtained by compressing the subject image data using conditions so as that it can be decompressed to the same image quality as the subject image data, and is stored in the image server 40 (Step P2).

Next the original image data is compressed based on the compression conditions stored in the image server 40 to thereby create the first compressed image data (Step P3).

The compressed image data that was created and the compression conditions used for creating the compressed image data are stored in the image server 40 (Step P4).

In the card writer 60, the first compressed image data and the related information which is stored in the image server 40 (which corresponds to the first compressed image data) are stored on the IC chip 52 which is in the subject authentication card 50 (Step P5).

In this manner, a subject authentication card 50 is created on which is stored first compressed image data and related information which corresponds thereto.

Next the procedure for updating the subject authentication card 50 is described by Step S1-S10. In the updating procedure, the first compressed image data which is recorded on the IC chip 52 which is provided in the subject authentication card 50 may be tampered with or may be changed to another compressed image data, and thus a verifying operation is necessary. When this verifying operation is carried out, the data forms the third compressed image data.

First, the third compressed image data (which is assumed to be the first compressed image data, but this has not yet been confirmed) and related information (including ID number) which is recorded on the IC chip 52 is read from the subject authentication card 50 by the card reader 30 (Steps S1 and S2).

Next, the original image data file and compression conditions which correspond to the ID number are specified from the image server 40 based on the ID number that has been obtained as related information, and this is read via the network N (Step S3)

The specified original image data is displayed at the monitor screen of the display means 13. The third compressed image data or the image data that is obtained by encoding the original image data may also be displayed on the monitor screen.

In addition, the original image data is compressed based on the specified compression conditions (for example, JPEG 2000 format and desired file size of 2 KB) and the second compressed image data is created (Step S4). The bit planes are used as dividing units for the layer division, and by deleting the codes for layer information exceeding 2 KB (or more accurately the capacity of 2 KB minus the capacity for the metadata portion) as compressed image data, the second compression data is created.

Next, the second compressed image data and the third compressed image data which is read from the subject authentication card 50 are compared at the binary data level and verification is performed (Step S5).

In the case where the second compressed image data and the third compressed image data are determined to match, or in other words if the third compressed image data and the first compressed image data are determined to be the same as a result of this verification, (Yes in Step S6), the photographic image data photographed by the digital camera 20 and the original image data are verified (Step 7). The similarity level is calculated based on the characteristic amounts of both sets of image data and if the similarity level exceeds a threshold value, the card holder is determined to be the true owner of the card.

If a determination is made that the photographic image data and the original image data match (Yes in Step 8), use of the system is possible within a preset range in accordance with the photographed subject (Step S9), and the photographed subject authentication process ends.

In the case where in Step S6, the second compressed image data and the third compressed image data are determined to not match (No in Step S6), or when in Step 8, the photographic data and the original image data do not match (No in Step S8), it becomes impossible to use the system (Step S10) and the photographed subject authentication process ends.

In addition, the determination as to whether that the facial image that is displayed on the monitor or the facial image that is printed on the card is the same person as the card holder, can be done by visual determination by the operator. In this case, visual confirmation can also be done from a remote location. In other words, the photographed facial image and the original data image on the image server 40 may be obtained by an operator who is in a remote location via the network N, and the results of the comparison and verification may be sent to the system. Furthermore, the card holder may perform an operation such as pressing a preset button only in the case where data verification by the device does not match, or alternatively the operator may perform the verification.

According to the photographed subject authentication system 1, original image data corresponding to the third compressed image data read from the photographed subject authentication card 50 based on the related information obtained from the photographed subject authentication card 50 and the compression conditions are specified, and second compressed image data is created by compressing the specified original image data based on the specified compression conditions, and because the second compressed image and the third compressed image data read from the photographed subject authentication card 50 are compared and verified, a determination can be made as to whether the third compressed image data recorded on the photographed subject authentication card 50 is that created from the original image data stored at the image server 40. That is to say, a determination can be made as to whether the third compressed image data and the first compressed image data are the same, and a determination can thus be made as to whether the information on the photographed subject authentication card 50 has been tampered with.

Furthermore, by using the original image data and the results of verifying the photographic image data photographed by the digital camera 20 together, accurate photographed subject authentication can be performed.

Also, because the image server 40 stores the original image data which is compressed using conditions such that decompression back to the same image quality is possible, and the size is the minimum size and more photographed subject data can be stored. However, when the storage capacity of the image server 40 is sufficient, image data which has not been compressed may be stored.

Specific examples of locations where photographed subject authentication is performed include government offices, post offices, banks and locations where credit cards are used. Also the verification results may be used for making decisions for renewal of identification cards such as licenses, issuing of seal registration certificates, issuing of family register documents and the like. Also, this invention may applied in managing entry into buildings where priority is placed on security through employee identification, and only persons who have permission to access are issued a special card which allows limited access by data. It may also be used for motor vehicles whose engines operate only when allowed by using a driver's license.

It is to be noted that the description of the above embodiment is an example of a suitable photographed subject authentication system of this invention, and the present invention is not to be limited thereto. The detailed configuration and operation of the structural components of the photographed subject authentication system may be suitably modified without departing from the scope of the present invention.

For example, in the above-described embodiment, the compressed image data reading means is the card reader 30 which reads the data recorded on the IC chip 52 which is in the card, but a card reader which reads data recorded on other storage media may be used, or in the case where the data is recorded as a two-dimensional barcode, a barcode reader may be used. These devices may be those that are generally available.

Furthermore, in the above-described embodiment, the card reader 30 which reads related information recorded on the IC chip 52 is described, but when the related information such as ID number and name which is recorded on the card surface is to be obtained a scanner may be used, and when it is to be obtained by manual input, and input means such as keyboard, mouse or the like may be used.

Furthermore, the image obtained by photographing the subject is not limited to a facial image of the subject. The subject may be a person, an object, or animal, but the portion photographed must be a portion that can identify the photographed subject and has high distinguishing characteristics. For example, in the case of a person, aside from the face, biological information on fingerprints, the retina, the pupils, the shape of the palm and the like may be used. In the case where the photographed subject is an object, the seal surface (if a registered seal) and the like may be used. Furthermore, in the case where the photographed subject is an animal, the nose print or ear print may be used.

1. A photographed subject authentication system which performs photographed subject authentication using a photographed subject authentication card, comprising:
a storing device for storing original image data obtained from a photographed subject and compression condition for compressing the original image data to obtain first compressed image data;
a first compression device for compressing the original image data based on the compression condition;
a compressed image data writing device for writing the first compressed image data and related information corresponding to the photographed subject into the photographed object authentication card;
a compressed image data reading device for reading a third compressed image data from the photographed subject authentication card;
a related information obtaining device for obtaining related information corresponding to the photographed subject from the photographed subject authentication card;
a data specifying device for specifying the original image data corresponding to the first compressed image data and the compression condition read from the storing device based on the obtained related information;
a second compression device for compressing the specified original image data based on the specified compression condition to obtain second compressed image data; and
a data verifying device for comparing the third compressed image data with the second compressed image data to determine whether the third compressed image data is equal to the second compressed image data,
wherein the data verifying device determines that the third compressed image data is equal to the first compressed image data when the result of the comparison is that the third compressed image data is equal to the second compressed image data.

2. The photographed subject authentication system of claim 1, wherein the compression conditions are attached as metadata to at least one of the original image data and the first compressed image data.

3. The photographed subject authentication system of claim 1, wherein the original image data is image data compressed using conditions by which the photographed subject image data obtained by photographing the photographed subject can be decompressed to have image quality which is the same as the photographed subject image data.

4. The photographed subject authentication system of claim 3, wherein the compression format used when creating the original image data from the photographed subject image data and the compression format used when creating the first and second compressed image data from the original image data are the same compression format, and the first and second compression image data are created by reducing the data amount of the compressed image data in its original state without decoding to the original image data.

5. The photographed subject authentication system of claim 1, further comprising:
a photographed subject image obtaining device for obtaining image data from the photographed subject; and
an image verifying device for verifying the first compressed image data read by the compressed image data reading device or the specified original image data specified from the specifying device with the image data obtained by the photographed subject image data obtaining device, wherein the photographed subject authentication is performed based on the results of the verification by the image data verifying means and the results of the verification by the image verifying device.

6. The photographed subject authentication system of Clam 1, wherein the photographed subject image is recorded on the surface of the photographed subject authentication card.

7. The photographed subject authentication system of claim 1, further comprising:
a display means for displaying at least one of the first compressed image data read by the compressed image data reading device and the original image data specified by the data specifying device.

8. A photographed subject authentication system which performs photographed subject authentication using a photographed subject authentication card, comprising:
a storing device for storing original image data obtained from a photographed subject and compression condition for compressing the original image data;
a compressed image data reading device for reading a third compressed image data from the photographed subject authentication card;
a related information obtaining device for obtaining related information corresponding to the photographed subject from the photographed subject authentication card;
a data specifying device for specifying the original image data and the compression condition read from the storing device based on the obtained related information; and
a data verifying device for comparing the third compressed image data with the compressed-original image data compressed based on the specified compression condition to determine whether the third compressed image data is equal to the compressed-original image data,
wherein the data verifying device determines that the third compressed image data is valid when the result of the comparison is that the third compressed image data is equal to the compressed-original image data.
